(19) United States
(12) Patent Application Publication
(10) Pub. No.: US 2008/0192500 A1
(43) Pub. Date: Aug. 14, 2008

(54) Terminal apparatus

(75) Inventor: Yoshihiko Kaito, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/790,948

(22) Filed: Apr. 30, 2007

(30) Foreign Application Priority Data
Feb. 13, 2007 (JP) 2007-031431

(51) Int. Cl. F21V 7/05

(52) U.S. Cl. 362/603

(57) ABSTRACT

An electronic apparatus including an optical waveguide formed in direct to the housing thereof by comprising an outer case which is formed partly or entirely of transparent resin material, an optical waveguide provided to the transparent resin material of the outer case and a light emitting element to radiate the light flowing in the optical waveguide. Accordingly, the electronic apparatus itself can radiate the light freely by confining the light within the optical waveguide. Moreover, even if a flaw is generated on the surface of case, any influence is given to the quantity of light.

### BACKGROUND OF THE INVENTION

1. Field of the Invention

The present invention relates to an outer case for housing of an electronic apparatus such as a cell phone, an electronic dictionary, and a personal computer.

2. Description of the Related Art

In these years, sales competition of a small size terminal apparatus, such as a mobile type electronic apparatus, is becoming severe and design of such a terminal apparatus product is very important with respect to both the external appearance as well as the functions. Moreover, a cell phone, for example, is particularly diversified in its application mode and it is desirable for such cell phone that visual displays and notifying methods other than notification by sound can be used more effectively.

To such request, a mobile terminal apparatus has been proposed (for example, Japanese laid-open patent publication No. 2004-80390). This mobile terminal apparatus emits light in accordance with a pattern of a panel by arranging a light emitting section at an external surface of a housing and covering such light emitting section with a panel including a semi-transparent section or a transparent section.

Moreover, an apparatus has also been proposed (for example, Japanese laid-open patent publication No. 2005-292490). This apparatus can realize decorated display by providing a vertical cavity surface light emitting device at a front surface of an outer case and also by providing a decorating section to a light emitting surface of such vertical cavity surface light emitting device and then irradiating the decorating section with the light. In addition, an apparatus has also been proposed (for example, Japanese laid-open patent publication No. 2003-283616), wherein a light conductive material is provided to a removable outer panel for emission of light.

However, light emission of the outer case disclosed in the Japanese laid-open patent publications No. 2004-80390 and No. 2005-292490 is realized with only one light source and a region formed by marking or patterning over the case is capable of emitting the light using a single light source. Therefore, it has been impossible for respective regions formed by the marking and patterning to simultaneously emit the lights of different colors. Moreover, since the entire part of the panel emits the light, if a flaw is generated on the front surface of housing and outer case, the light is leaked from such defective area. Accordingly, problems are generated here. For example, a part which should not radiate the light emits the light and insufficient quantity of light is caused by such leakage of light. In addition, even if a plurality of light sources of different colors are provided, it has been impossible to allow only the centralized part which should emit the light to emit the light in accordance with the marking and patterning on the case.

Moreover, in the case where a light conductive material is provided to a panel as disclosed in the Japanese laid-open patent publication No. 2003-283616, it is undesirable to add exclusive components to the outer case of the housing under the condition that a high-performance, small-size and low price product is desired.

### SUMMARY OF THE INVENTION

It is an object of the present invention to provide an electronic apparatus including an outer case which is formed in a simplified structure, and suitable for simultaneous light emission at a plurality of regions in different colors and assures a higher degree of freedom in design without deterioration in rigidity.

In view of achieving the object mentioned above, according to an aspect of the present invention a terminal apparatus is provided comprising an outer case formed of a resin material which is partly or entirely transparent, an optical waveguide provided to the transparent resin material of the outer case, and a light emitting element for radiating the light flowing into the optical waveguide.

The optical waveguide according to the present invention has a refractive index of light which is higher than that of a peripheral part.

The optical waveguide according to the present invention includes an inclining part at a part thereof and radiates the light of the light emitting element to the inclining part.

The optical waveguide according to the present invention includes a mirror surface part at a part thereof and radiates the light of the light emitting element to the mirror surface part.

The light emitting element according to the present invention is provided with a surrounding member at a peripheral portion thereof.

In accordance with embodiments of the present invention, a plurality of light emitting elements for different colors may be provided.

In accordance with embodiments of the present invention, a rough surface is provided to a case surface of the optical waveguide or to the side of a case surface of the optical waveguide.

In accordance with embodiments of the present invention an outer case of an electronic apparatus comprises a resin material which is partly or entirely transparent, and an optical waveguide for guiding the light of a light emitting element formed to the transparent resin material.

According to the present invention, following effects can be attained.

According to the present invention, since an optical waveguide is formed to a housing of an electronic apparatus, the housing of electronic apparatus can freely emit the light by confining the light within the optical waveguide. Moreover, if the front surface of case is given a flaw, it does not give any influence on the quantity of light. In addition, since the optical waveguide is formed directly on the outer case, this optical waveguide can be formed easily without increase in the special processes or the number of components. Therefore, the housing of electronic apparatus does not deteriorate rigidity thereof.

According to the present invention, the light can be confined within the central region of the optical waveguide by setting a refractive index of light to a value higher than that at the peripheral part.

According to the present invention, reflection of the incident light can be reduced by inclining a light irradiating port of the optical waveguide.

According to the present invention, a larger quantity of light can be incident effectively to the optical waveguide by inclining the light irradiating port of the optical waveguide and moreover finishing such light irradiating port as a mirror surface.

According to the present invention, leakage of extra light can be prevented by providing a surrounding member to the periphery of the light emitting element.

According to the prevent invention, mixture of colors can be prevented and distinct light can be maintained without giving any influence on the other light emitting elements with the light of each light emitting element by providing a surrounding member to shield the light to the periphery of the light emitting elements.

According to the present invention, easier watching can be realized by finishing the front surface of the case of optical waveguide as a rough surface because the leaked light can be picked up and the light is scattered at the rough surface.

Moreover, according to the present invention, it is possible to provide an outer case of electronic apparatus which can introduce versatile light emitting modes without mounting of exclusive components and circuits by employing a structure that the optical waveguide is formed on the outer case of the electronic apparatus.

### BRIEF DESCRIPTION OF THE DRAWING

FIG. 1 is an external view of a cell phone of a first preferred embodiment of the present invention;

FIG. 2 is a rear view of the cell phone of the first preferred embodiment of the present invention;

FIG. 3 is a rear view of a display section of the cell phone of the first preferred embodiment of the present invention;

FIG. 4 is an external view of the cell phone in a condition where the cell phone is closed;

FIG. 5 is a cross-sectional view of a housing of the cell phone observed along the line A-B in FIG. 4;

FIG. 6 is a cross-sectional view of the cell phone observed along the line C-D in FIG. 4;

FIG. 7 is the external view of the cell phone of the present invention;

FIG. 8 is the external view of the cell phone of a second preferred embodiment of the present invention;

FIG. 9 is a cross-sectional view of the cell phone observed along the line E-F in FIG. 8;

FIG. 10 is a structural diagram of circuit of the cell phone;

FIG. 11 is a flowchart of a light emitting control process; and

FIG. 12 is a flowchart of a light emitting pattern detecting process.

### DESCRIPTION OF THE PREFERRED EMBODIMENTS

A description of preferred embodiments of the present invention will be provided below with reference to the accompanying drawings. In the following description, a cell phone will be explained as an example of the electronic apparatus. However, the electronic apparatus may be other devices, such as a personal computer, an electronic dictionary, or any type of terminal device.

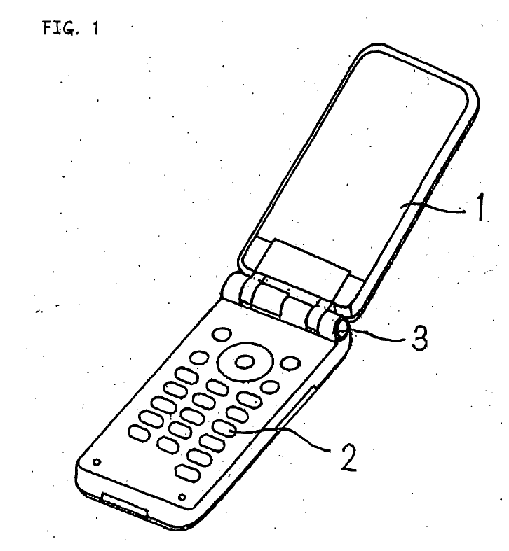

FIG. 1 is a diagram showing an external view of a cell phone in accordance with a first preferred embodiment of the present invention. As shown in FIG. 1, the cell phone includes a display section 1, which is a main display region to display various menus of the cell phone and a state indicating termination of a call. The cell phone also includes an input manipulating section 2 with which a user can manipulate input of characters using input keys, and a rotatable opening and closing section 3. Using the rotatable opening and closing section 3 as an axis, the side of display section 1 and the side of input manipulating section 2 can be opened and closed rotatably.

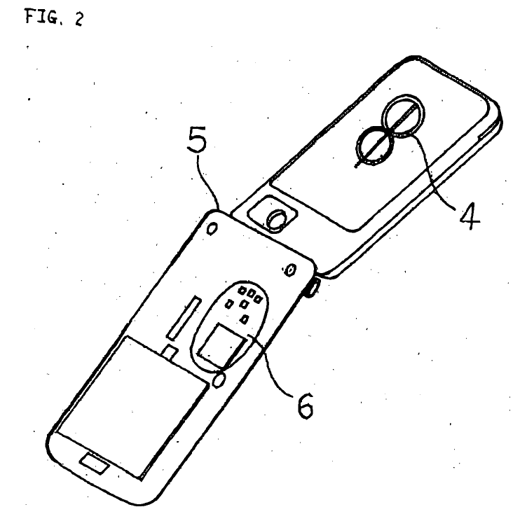

FIG. 2 is a diagram of the cell phone shown in FIG. 1 observed from a side opposite that shown in FIG. 1. As shown in FIG. 2, a light emitting section 4 is formed in an outer case. At the internal side where a rear cover is removed, a radio section (antenna) 5 and a transmitting and receiving section 6 are arranged.

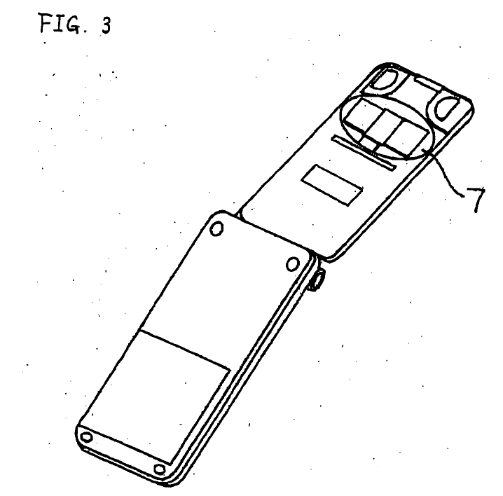

FIG. 3 shows an internal view of a control section 7 of the first preferred embodiment of the invention. The cell phone is capable of notifying various conditions, such as incoming call or incoming E-mail, indication of an originator of the call with single watching of glimpse, and missed call state, with radiation of the light from the light emitting section 4 of the outer case only with single watching of glimpse of the cell phone without any manipulation thereof.

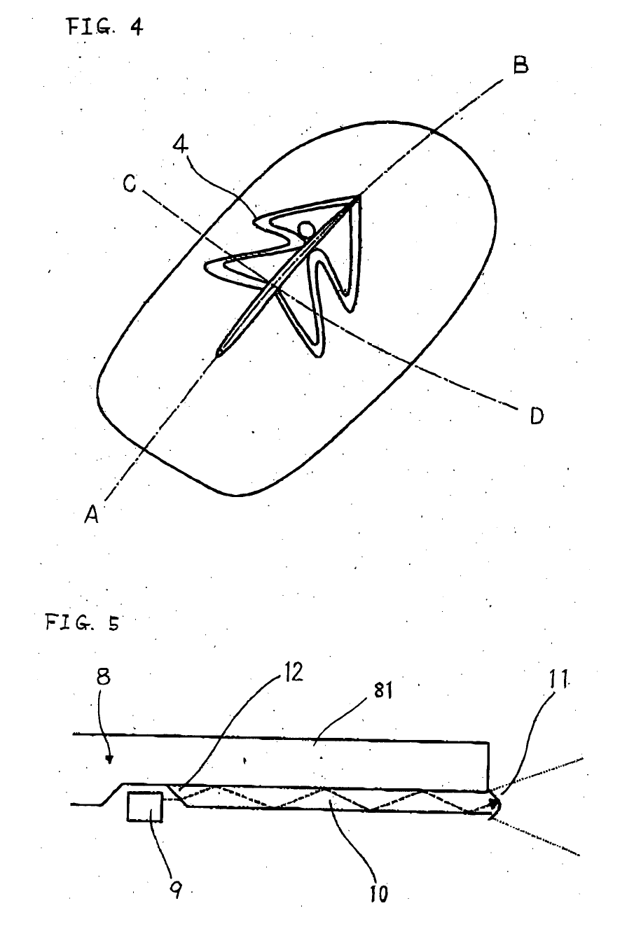

FIG. 4 is a diagram showing the external appearance of the cell phone in the condition that the cell phone is closed through the rotatable opening and closing section 3 shown in FIG. 1. As shown in FIG. 4, the light emitting section 4 is seen when the cell phone is closed. In accordance with the first preferred embodiment of the present invention, variable conditions of the cell phone can be expressed with light emitting patterns and colors of light of the light emitting section 4.

FIG. 5 is a cross-sectional view along the line A-B of the housing of the cell phone shown in FIG. 4. The housing 8 includes an outer case 81; a light emitting section 9; an optical waveguide 10; and a lens 11.

In the cell phone of the first preferred embodiment of the present invention, an optical waveguide 10 having a refractive index higher than that of a peripheral part formed of only polymethyl methacrylate (PMMA) is formed by forming a groove having a rough surface to the area which should emit the light through formation of the optical waveguide 10 in the housing 8 using a transparent resin material, for example, PMMA for the outer case 81 of the housing 8, embedding a fluorine system resin having a refractive index higher than that of PMMA to the internal side of the groove, and by depositing the fused PMMA again from the upper part of the embedded fluorine system resin.

Otherwise, the optical waveguide 10 having the refractive index higher than that of the peripheral part is formed by supplying a low molecule material which is fused through heat treatment to show the effect of lowering the refractive index lower than that of the area to emit the light to the part other than the area to emit the light using the transparent resin, for example, polymethyl methacrylate (PMMA) to the outer case 81 of the housing 8.

That is, it is required to make the refractive index of the optical waveguide through which the light flows higher than that of the peripheral part such that the light can be confined within the optical waveguide by reflecting the light within the optical waveguide. Moreover, the light can also be emitted from the boundary of the optical waveguide by propagating the light of the light emitting element 9 within the optical waveguide.

In addition, a part which should be finished as the mirror surface may be provided to a light-irradiating port 12 of the light emitting element 9 by permitting the fluorine resin to emerge from a part of PMMA on the occasion of forming the optical waveguide 10 using PMMA as mentioned above. The part finished as the mirror surface at a part of the optical waveguide 10 is irradiated with the light from the light emitting element 9. Useless irregular reflection may be eliminated and loss of light when the light is inputted may also be reduced by forming such mirror surface area.

Moreover, reflection of incident light can be reduced and thereby a large quantity of light can be inputted to the optical waveguide 10 by inclining the light irradiating port 12 of the optical waveguide 10 finished as the mirror surface area.

The, lens 11 may be provided in the incident side of an LED or in the light emitting side at the external surface of the housing. When the lens 11 is provided in the incident side of the light emitting element 9, the lens 11 can effectively guide the light into the optical waveguide 10. Moreover, when the lens 11 is provided in the light emitting side at the external surface of the housing, the lens 11 can extract the light to the external side as the parallel light. Accordingly, the light may be used as a pointer or used for a communication means as the extracted modulating signal.

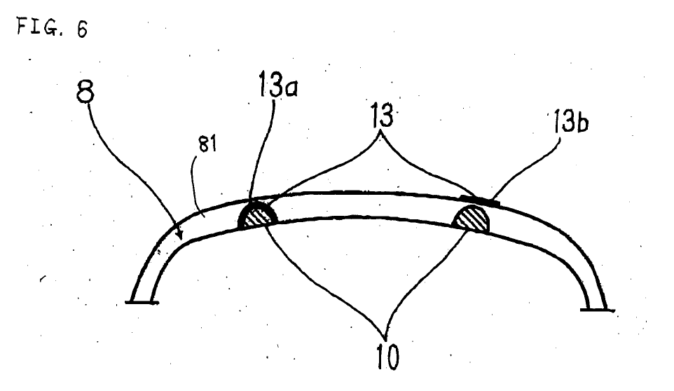

FIG. 6 is a cross-sectional view of the cell phone observed along the line C-D in FIG. 4. A rough surface 13 is provided at the front surface side of housing 8 concerning the optical waveguide 10 in FIG. 6. Since the light has the characteristic of being easily reflected at a smooth surface, it is a disadvantage that the light reflected within the optical waveguide 10 cannot be easily observed. Therefore, the light can be scattered and thereby can be observed more easily by providing the rough surface 13 at the area near the front surface side of the housing 8 concerning the optical waveguide 10 as mentioned above.

It is preferable to form the rough surface 13 at an area as near as possible to the optical waveguide 10. It may be assumed here to provide the rough surface 13 area at the groove of the optical waveguide 10, as illustrated by 13a, and at the front surface of case opposing to the optical waveguide 10, as illustrated by 13b.

The rough surface 13 may be formed at the groove part of the optical waveguide 10 by making rough the surface of the groove through a blast process and then forming the optical waveguide 10 thereto. Otherwise, such rough surface 13 may also be formed by implementing the painting process to the groove part using paint including coarse particles.

Such rough surface 13 may be formed to the outer case surface by conducting the blast process with the area other than that to form the rough surface masked. Otherwise, it is also permitted to conduct the painting finished with rough surface or to coat a film to the case.

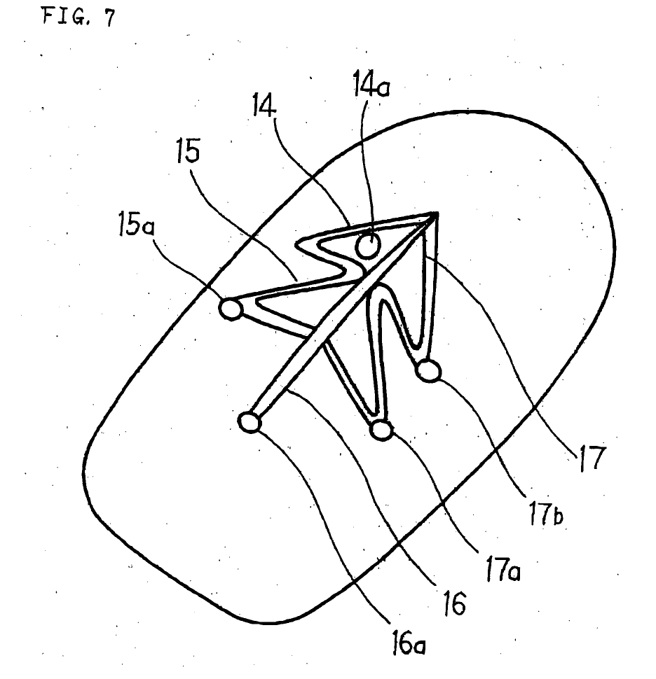

As shown in FIG. 7, with the structure mentioned above, four optical waveguides 14, 15, 16, and 17 are provided to the outer case of the housing and the light emitting elements are allocated to respective optical waveguides as the light sources 14a, 15a, 16a, 17a and 17b. Since the light emitting elements of different colors are provided, each optical waveguide 14-17 can radiate different colors. Moreover, it is also possible that the areas where respective light sources are allocated can radiate in respective colors by allocating a plurality of light sources 17a, 17b for only one optical waveguide 17.

Namely, a plurality of portions to form the optical waveguide are provided and light sources are respectively provided to respective optical waveguides for irradiation of light. When respective light sources emit the lights in different colors, each optical waveguide can radiate in different color. Moreover, illuminations of different patterns may be realized by controlling the timing of light emission of each light source. As a result, multi-color and distinctive illuminations can be designed on the housing of cell phone unlike the illumination in the related art.

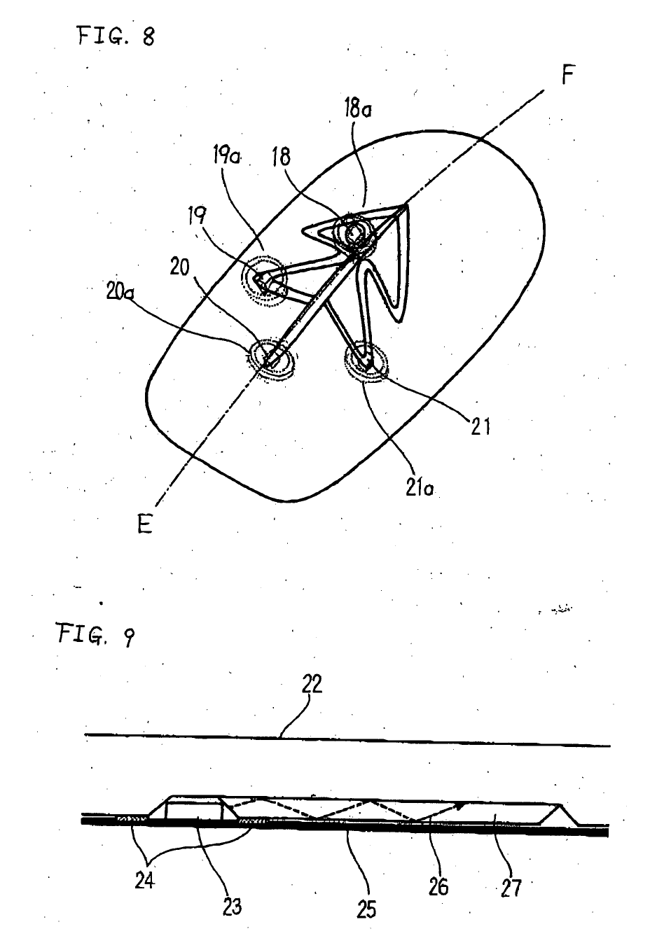

FIG. 8 shows a second preferred embodiment of the cell phone of the present invention. In FIG. 8, rib sections 18a to 21a are provided as light shielding members to shield the excessive light to be leaked around the light emitting elements 18 to 21 provided to each optical waveguide.

FIG. 9 is a cross-sectional view of the cell phone observed along the line E-F of FIG. 8. As shown in FIG. 9,the cell phone includes a surface 22 of the outer case; a light emitting element 23; a light shielding member 24; a circuit board 25 provided with light emitting elements; a light path of the light emitting diode 26, and an optical waveguide 27.

In the structure mentioned above, since the rib sections 18a-21a are provided as the members for shielding the light around the light emitting diodes to prevent mixture of the lights of respective light emitting elements, maintaining of distinctive light without any mixture of colors can be realized even when the light emitting elements of different colors are adjacently allocated.

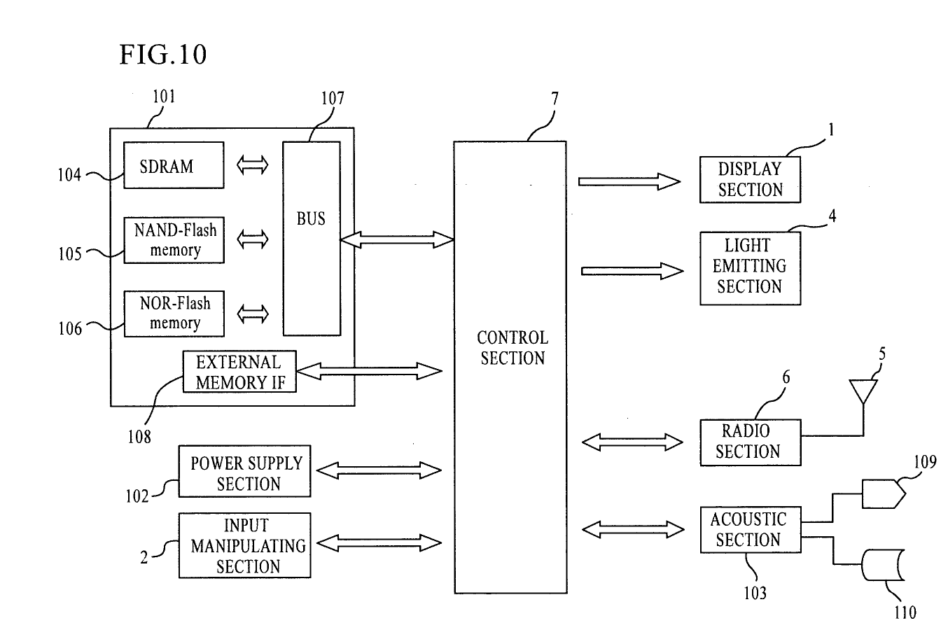

FIG. 10 is a block diagram showing an example of circuit structure of an electric circuit of a cell phone in accordance with the present invention. The circuit structure of this cell phone will be explained with reference to FIG. 10.

As shown in FIG. 10, the cell phone is provided with a fixed side housing including an input manipulating unit 2 in addition to the telephone function and mail transmitting and receiving function or the like and a moved side housing including the principal display screen 1, which may be rotatable through the rotatable opening and closing section 3.

Accordingly, this cell phone comprises an input manipulating section 2, a display section 1, a control section (Central Processing Unit) 7, a memory section. 101, a power supply section 102, a radio section 6 and an acoustic section 103. The input manipulating section 2 is provided with a plurality of keys for inputting telephone numbers and characters to generate a mail document. The display section 1 is capable of controlling displays on the principal display screen The control section 7 executes programs stored in the memory section 101 to conduct various control operations such as fetching of detecting information and control information such as input at the input manipulating section 2, read and write of information in the memory section 101, control of display screen of the display section 1, and light emission control of the light emitting section. 4.

The memory section 101 stores a control program including the processes such as switching of displays, switching of display layout and execution of functions corresponding to the opening and closing, other programs, and various data. In this preferred embodiment, this memory section 101 is constituted with an SDRAM (Synchronous Dynamic Random-Access Memory) 104, NAND-Flash memory 105, and NOR-Flash memory 106 which are connected to the control section via a bus 107.

The SDRAM 104 also constitutes a work area to execute the program which has been loaded by reading from the NOR-Flash memory 106 in order to execute the arithmetic process and generate control information. The NAND-Flash memory 105 stores various data to form a database. The NOR-Flash memory 106 stores various programs such as OS (Operating System) and control program.

An external memory IF (interface). 108 is connected with an external memory such as a memory card and this external memory stores telephone numbers, address data such as mail address and various contents.

The power supply section 102 comprises a battery, a battery charging circuit controlled by the control section 7, a stabilizing circuit, and a power supply control circuit in order to feed various functioning sections such as the radio section 6.

The radio section 6 realizes transmission and reception for voice communication and data communication of mail or the like through an antenna 5 to conduct modulating process of voice and data and demodulating process of voice and data from the radio signal.

The acoustic section 103 outputs terminated voice signal through a speaker 109 or extracts and amplifies the transmitting voice signal from a microphone 110.

The light emitting section 4 includes a light emitting element, such as an LED or the like mentioned in this preferred embodiment, and a drive control section for this light emitting element. When an incoming call to the cell phone, the light emitting section 4 emits the light in the light emitting pattern and color in accordance with the state of light emitting section 4.

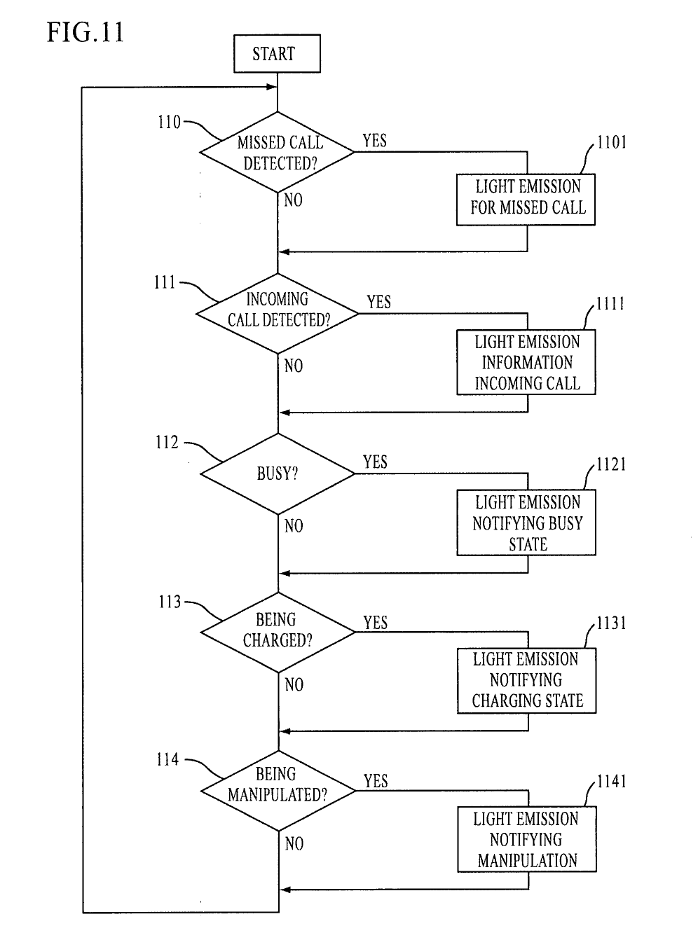

FIG. 11 shows a flowchart as an example of the control of the light emitting section 4 in accordance with the state of cell phone. Here, the state of cell phone may be classified, for example, missed call, incoming call, busy, charging and manipulation of keys.

First, the cell phone checks missed call. When the missed call is detected (YES in the step 110), light emission is conducted in the missed call pattern (step 1101). Next, when incoming call is detected (YES in the step 111), light emission is conducted in the incoming pattern (step 1111). When the cell phone is already in the busy state. (YES in the step 112), light emission is conducted in the busy pattern (step 1121) When the cell phone is in the charging state (YES in the step 113), light emission is conducted for notification of charging state (step 1131) and light emission may also be controlled to be turned OFF upon completion of charging process. Moreover, when a user is manipulating the cell phone to realize a certain function, for example when the user executes key manipulation or opening/closing manipulation (YES in the step 114), light emission is conducted in the light-emitting pattern corresponding to the manipulation (step 1141).

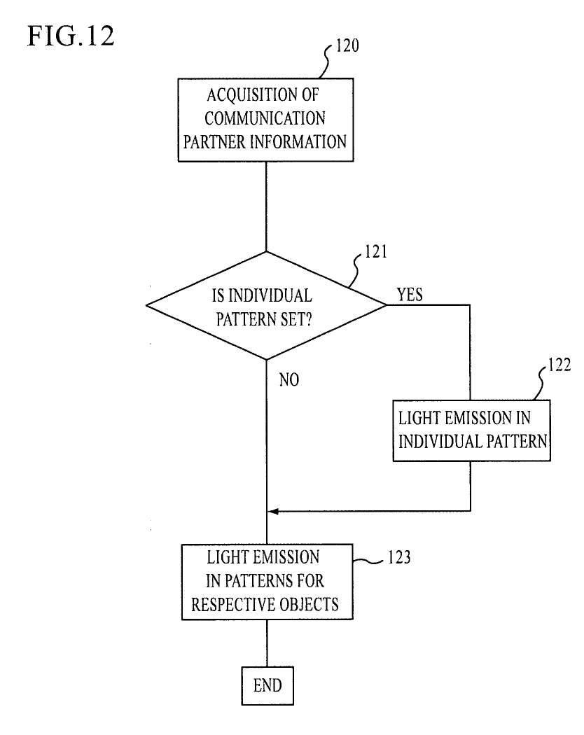

FIG. 12 shows a flowchart of light emitting pattern detecting control in the state of missed call and the states of incoming call and busy or the like where a communication partner is attending in FIG. 11.

In the case of incoming call under the condition that a communication partner is attending or light emission for notifying state of communication, the partner information is acquired (step 120) to check whether the light emitting pattern is individually set or not (step 121). When the light emitting pattern is set individually for the communication partner (YES in the step 121), notification under more excellent visible recognition may be realized by controlling the light emitting section to emit the light in individual colors and patterns (step 122).

In the structure described above, light emission having more excellent impact may be designed in the condition that the light emitting element can emit the light in the independent patterns of different colors in each optical waveguide through the control of electronic circuits. In this case, each light emitting element, for example, each LED is surrounded with the rib section or cushions so that the lights of light emitting elements, for example, LEDs are never mixed with each other. Accordingly, more distinctive lights can be maintained by shielding the lights of respective colors to eliminate influence on the other colors.

Although preferred embodiments have been shown and described, it will be appreciated by those skilled in the art that modifications may be made in these embodiments without departing from the principles and spirit of the invention, the scope of which is defined in the appended claims and their equivalents. For example, in the preferred embodiments, the LED is described as the light emitting element. However, the present invention is not limited to an LED as the light emitting element, and other types of light emitting elements may be employed.

What is claimed is:

1. A terminal apparatus, comprising:
an outer case formed of a resin material which is partly or entirely transparent;
an optical waveguide provided to said transparent resin material of said outer case; and
a light emitting element for radiating light flowing into said optical waveguide.

2. The terminal apparatus according to claim 1, wherein the optical waveguide has a refractive index of light which is higher than that of a peripheral section.

3. The terminal apparatus according to claim 1, wherein the optical waveguide includes an inclining section at a section thereof and radiates the light of said light emitting element to said inclining section.

4. The terminal apparatus according to claim 1, wherein the optical waveguide includes a mirror surface part at a part thereof and radiates the light of said light emitting element to said mirror surface section.

5. The terminal apparatus according to claim 1, wherein the light emitting element is provided with a surrounding member at a peripheral porton thereof.

6. The terminal apparatus according to claim 1, wherein a plurality of light emitting elements for different colors are provided.

7. The terminal apparatus according to claim 1, wherein a rough surface is provided to a case surface of said optical waveguide or to the side of a case surface of said optical waveguide.

8. The terminal apparatus according to claim 2, wherein the optical waveguide includes an inclining section at a section thereof and radiates the light of said light emitting element to said inclining section.

9. The terminal apparatus according to claim 2, wherein the optical waveguide includes a mirror surface part at a part thereof and radiates the light of said light emitting element to said mirror surface section.

10. The terminal apparatus according to claim 2, wherein the light emitting element is provided with a surrounding member at a peripheral portion thereof.

11. The terminal apparatus according to claim 2, wherein a plurality of light emitting elements for different colors are provided.

12. The terminal apparatus according to claim 3, wherein the optical waveguide includes a mirror surface part at a part thereof and radiates the light of said light emitting element to said mirror surface section.

13. The terminal apparatus according to claim 3, wherein the light emitting element is provided with a surrounding member at a peripheral portion thereof.

14. The terminal apparatus according to claim 3, wherein a plurality of light emitting elements for different colors are provided.

15. The terminal apparatus according to claim 4, wherein the light emitting element is provided with a surrounding member at a peripheral portion thereof.

16. The terminal apparatus according to claim 4, wherein a plurality of light emitting elements for different colors are provided.

17. The terminal apparatus according to claim 5, wherein a plurality of light emitting elements for different colors are provided.

18. An,outer case for an electronic apparatus, comprising:
a resin material which is partly or entirely transparent; and
an optical waveguide for guiding the light of a light emitting element formed to said transparent resin material.
